(19) United States
(12) Patent Application Publication
(10) Pub. No.: US 2020/0298726 A1
(43) Pub. Date: Sep. 24, 2020

(54) VEHICLE

(71) Applicant: TOYOTA JIDOSHA KABUSHIKI KAISHA, Toyota-shi (JP)

(72) Inventors: Jun SATOH, Toyota-shi (JP); Keiichi MINAMIURA, Toyota-shi (JP); Manabu KATOH, Toyota-shi (JP)

(73) Assignee: TOYOTA JIDOSHA KABUSHIKI KAISHA, Toyota-shi (JP)

(21) Appl. No.: 16/825,643

(22) Filed: Mar. 20, 2020

(30) Foreign Application Priority Data
Mar. 22, 2019 (JP) 2019-054679

(51) Int. Cl. B60L 58/12; B60K 6/24; B60K 6/28; B60K 6/26; H02J 7/00

(52) U.S. Cl. CPC B60L 58/12; B60K 6/24; H02J 7/0048; B60K 6/26; H02J 7/00712; B60K 6/28

(57) ABSTRACT

A control device of a vehicle integrates an amount of degradation of positive electrode capacity of a storage battery during drive of a first predetermined distance. When an integrated value of the amount of degradation is equal to or larger than a first predetermined value, the control device performs a degradation suppressing control to suppress charging and discharging of the storage battery in a low state of charge range where a state of charge of the storage battery is lower than a predetermined ratio that accelerates degradation of the positive electrode capacity, compared with charging and discharging of the storage battery in the low state of charge range in an ordinary control.

### CROSS-REFERENCE TO RELATED APPLICATIONS

The present disclosure claims priority to Japanese Patent Application No. 2019-054679 filed Mar. 22, 2019, which is incorporated herein by reference in its entirety including specification, drawings and claims.

### TECHNICAL FIELD

The present disclosure relates to a vehicle equipped with an internal combustion engine, a storage battery that uses a nickel compound as a positive electrode material, and a control device that performs drive control including charge discharge control of the storage battery.

### BACKGROUND

A proposed vehicle includes an internal combustion engine and a storage battery configured as a nickel metal hydride battery or a nickel cadmium rechargeable battery and is configured to start charging of the storage battery when an SOC (state of charge) of the storage battery reaches a predetermined lower limit value and stop charging of the storage battery when the SOC reaches a predetermined upper limit value (as described in, for example, JP 2004-166350A). The vehicle of this proposed configuration increases and decreases the upper limit value and the lower limit value every time the state of the storage battery is changed over from charging to discharging in the state that the vehicle is not allowed to idle. This aims to eliminate the memory effect caused by repetition of charging and discharging between the upper limit value and the lower limit value of the SOC.

### SUMMARY

When a nickel storage battery that uses a nickel compound as a positive electrode material is used in a low SOC range (low state of charge range) where the state of charge is relatively low, the positive electrode capacity of the storage battery is likely to degrade. Accordingly, in the vehicle of JP 2004-166350A that thoroughly uses from a low SOC range to a high SOC range, degradation of the positive electrode capacity is likely to proceed significantly. Excessive degradation of the positive electrode capacity leads to performance degradation of the storage battery. There is accordingly a demand for improving the degradation of the positive electrode capacity.

A main object of a vehicle of the present disclosure provided with a storage battery that uses a nickel compound as a positive electrode material is to more appropriately control the progress of degradation of a positive electrode capacity of the storage battery by long-term use.

In order to achieve the above primary object, the vehicle of the present disclosure employs the following configuration.

The present disclosure is directed to a vehicle. The vehicle includes an internal combustion engine, a storage battery configured to be charged with electric power that is generated by using power from the internal combustion engine and to use a nickel compound as a positive electrode material and a control device configured to set a state of charge of the storage battery based on a condition of the storage battery and to perform drive control that includes charge and discharge control of the storage battery, based on the set state of charge. The control device integrates an amount of degradation of positive electrode capacity of the storage battery during drive of a first predetermined distance, and when an integrated value of the amount of degradation is equal to or larger than a first predetermined value, the control device performs a degradation suppressing control to suppress charging and discharging of the storage battery in a low state of charge range where the state of charge is lower than a predetermined ratio that accelerates degradation of the positive electrode capacity, compared with charging and discharging of the storage battery in the low state of charge range in an ordinary control.

The vehicle according to this aspect of the present disclosure integrates the amount of degradation of the positive electrode capacity of the storage battery during the drive of the first predetermined distance and performs the degradation suppressing control to suppress charging and discharging of the storage battery in the low state of charge range when the integrated value of the amount of degradation is equal to or larger than the first predetermined value, compared with charging and discharging of the storage battery in the low state of charge range in the ordinary control. Degradation of the positive electrode capacity of a nickel storage battery, which uses the nickel compound as the positive electrode material, proceeds when the storage battery is used in the low state of charge range. Performing the degradation suppressing control minimizes the use of the storage battery in the low state of charge range and thereby suppresses degradation of the positive electrode capacity. As a result, this more appropriately controls the progress of degradation of the positive electrode capacity by the long-term use and suppresses the performance degradation of the storage battery. The degradation suppressing control is performed only when the integrated value of the amount of degradation is equal to or larger than the first predetermined value. This configuration ensures the more sufficient performance of the storage battery and reduces the influence on the control of the vehicle, compared with a configuration of continuously performing the degradation suppressing control.

### BRIEF DESCRIPTION OF DRAWINGS

FIG. 1 is a configuration diagram illustrating the schematic configuration of a vehicle according to one embodiment of the present disclosure;

FIG. 2 is a block diagram illustrating a procedure of calculating the amount of capacity degradation Q;

FIG. 3 is a diagram illustrating one example of a charge discharge required power setting map;

FIG. 4 is a diagram illustrating one example of a start reference value setting map;

FIG. 5 is a flowchart showing one example of an amount of capacity degradation monitoring process;

FIG. 6 is a diagram illustrating a relationship between travel distance and accumulated amount of degradation;

FIG. 7 is a diagram illustrating changeover of control mode;

FIGS. 8A and 8B is a diagram illustrating an SOC use range in an ordinary control mode and an SOC use range in a degradation suppressing control mode;

FIG. 9 is a flowchart showing one example of a controlling state of charge setting process;

FIG. 10 is a diagram illustrating one example of a state of charge adjustment map; and

FIG. 11 is a configuration diagram illustrating the schematic configuration of another vehicle according to a modification.

### DESCRIPTION OF EMBODIMENTS

The following describes some aspects of the disclosure with reference to embodiments.

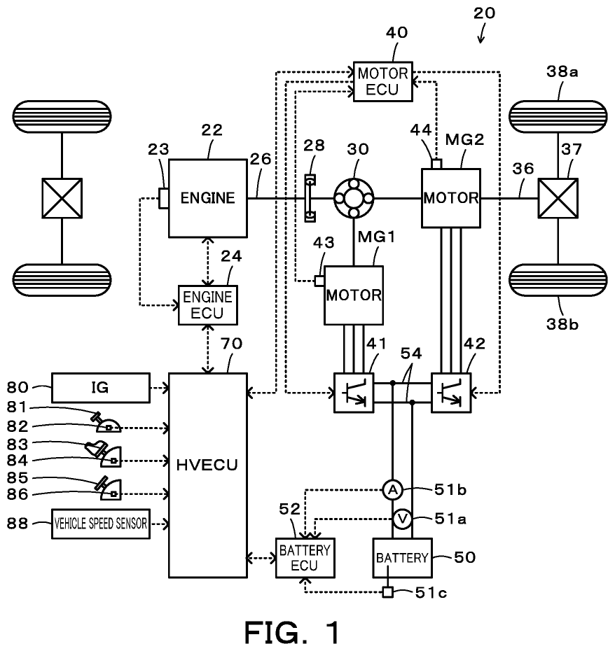

FIG. 1 is a configuration diagram illustrating the schematic configuration of a vehicle 20 according to one embodiment of the present disclosure. As illustrated, the vehicle 20 of the embodiment is configured as a hybrid vehicle including an engine 22, a planetary gear 30, motors MG1 and MG2, inverters 41 and 42, a battery 50, and a hybrid electronic control unit (hereinafter referred to as “HVECU”) 70.

The engine 22 is configured as an internal combustion engine that outputs power by using, for example, gasoline or light oil as a fuel. This engine 22 is operated and controlled by an engine electronic control unit (hereinafter referred to as “engine ECU”) 24.

The engine ECU 24 is configured as a CPU-based microprocessor and includes a ROM configured to store processing programs, a RAM configured to temporarily store data, input/output ports and a communication port, in addition to the CPU, although not being illustrated. Signals from various sensors required for operation control of the engine 22 are input into the engine ECU 24 via the input port. The signals input into the engine ECU 24 include, for example, a crank angle θcr from a crank position sensor 23 configured to detect a rotational position of a crankshaft 26 of the engine 22 and a throttle position TH from a throttle valve position sensor configured to detect the position of a throttle valve.

Various control signals for operation control of the engine 22 are output from the engine ECU 24 via the output port. The control signals output from the engine ECU 24 include, for example, a control signal to a throttle motor configured to regulate the position of the throttle valve, a control signal to a fuel injection valve, a control signal to an ignition coil integrated with an igniter and a variety of other control signals.

The engine ECU 24 is connected with the HVECU 70 via the respective communication ports to operate and control the engine 22 in response to the control signals from the HVECU 70 and to output data with regard to the operating conditions of the engine 22 to the HVECU 70 as needed basis. The engine ECU 24 calculates a rotation speed of the crankshaft 26, i.e., a rotation speed Ne of the engine 22, based on the crank angle θcr input from the crank position sensor 23.

The planetary gear 30 is configured as a single pinion-type planetary gear mechanism The planetary gear 30 includes a sun gear that is connected with a rotor of the motor MG1. The planetary gear 30 also includes a ring gear that is connected with a driveshaft 36 linked with drive wheels 38a and 38b via a differential gear 37. The planetary gear 30 further includes a carrier that is connected with the crankshaft 26 of the engine 22.

The motor MG1 is configured, for example, as a synchronous generator motor and has the rotor that is connected with the sun gear of the planetary gear 30 as described above. The motor MG2 is configured, for example, as a synchronous generator motor and has a rotor that is connected with the driveshaft 36. The inverters 41 and 42 are connected with the battery 50 via power lines 54. A motor electronic control unit (hereinafter referred to as “motor ECU”) 40 performs switching control of a plurality of switching elements (not shown) respectively included in the inverters 41 and 42, so as to rotate and drive the motors MG1 and MG2.

The motor ECU 40 is configured as a CPU-based microprocessor and includes a ROM configured to store processing programs, a RAM configured to temporarily store data, input/output ports and a communication port, in addition to the CPU, although not being illustrated. Signals from various sensors required for drive control of the motors MG1 and MG2 are input into the motor ECU 40 via the input port. The signals input into the motor ECU 40 include, for example, rotational positions θm1 and θm2 from rotational position detection sensors 43 and 44 configured to detect the rotational positions of the respective rotors of the motors MG1 and MG2. The input signals also include phase currents from current sensors configured to detect electric currents flowing in the respective phases of the motor MG1 and MG2.

The motor ECU 40 outputs via the output port, for example, switching control signals to the plurality of switching elements (not shown) included in the respective inverters 41 and 42. The motor ECU 40 is connected with the HVECU 70 via the respective communication ports to drive and control the motors MG1 and MG2 in response to the control signals from the HVECU 70 and to output data with regard to the driving conditions of the motors MG1 and MG2 to the HVECU 70 as needed basis. The motor ECU 40 calculates rotation speeds Nm1 and Nm2 of the respective motors MG1 and MG2, based on the rotational positions θm1 and θm2 of the respective rotors of the motors MG1 and MG2 input from the rotational position detection sensors 43 and 44.

The battery 50 is configured as a nickel storage battery that uses a nickel compound as a positive electrode material, for example, a nickel metal hydride battery or a nickel cadmium rechargeable battery. This battery 50 is connected with the inverters 41 and 42 via the power lines 54 as described above. The battery 50 is under management of a battery electronic control unit (hereinafter referred to as “battery ECU”) 52.

The battery ECU 52 is configured as a CPU-based microprocessor and includes a ROM configured to store processing programs, a RAM configured to temporarily store data, input/output ports and a communication port, in addition to the CPU, although not being illustrated. Signals from various sensors required for management of the battery 50 are input into the battery ECU 52 via the input port. The signals input into the battery ECU 52 include, for example, a battery voltage Vb from a voltage sensor 51a placed between terminals of the battery 50, a battery current Ib from a current sensor 51b mounted to an output terminal of the battery 50, and a battery temperature Tb from a temperature sensor 51c mounted to the battery 50.

The battery ECU 52 is connected with the HVECU 70 via the respective communication ports to output data with regard to the conditions of the battery 50 to the HVECU 70 as needed basis. The battery ECU 52 calculates a base value of a state of charge SOC, based on an integrated value of the battery current Ib of the battery 50 input from the current sensor 51b and then calculates the state of charge SOC by correcting the calculated base value according to the battery voltage Vb input from the voltage sensor 51a and the battery temperature Tb input from the temperature sensor 51c. The battery ECU 52 also calculates an input limit Win and an output limit Wout of the battery 50, based on the calculated state of charge SOC and the battery temperature Tb. The state of charge SOC denotes a ratio of the capacity of electric power dischargeable from the battery 50 to the overall capacity of the battery 50. The input limit Win and the output limit Wout of the battery 50 respectively denote a maximum chargeable power that is allowed to be charged into the battery 50 and a maximum dischargeable power that is allowed to be discharged from the battery 50. Furthermore, the battery ECU 52 calculates an amount of capacity degradation Q with a view to monitoring the degradation progress with regard to the positive electrode capacity of the battery 50.

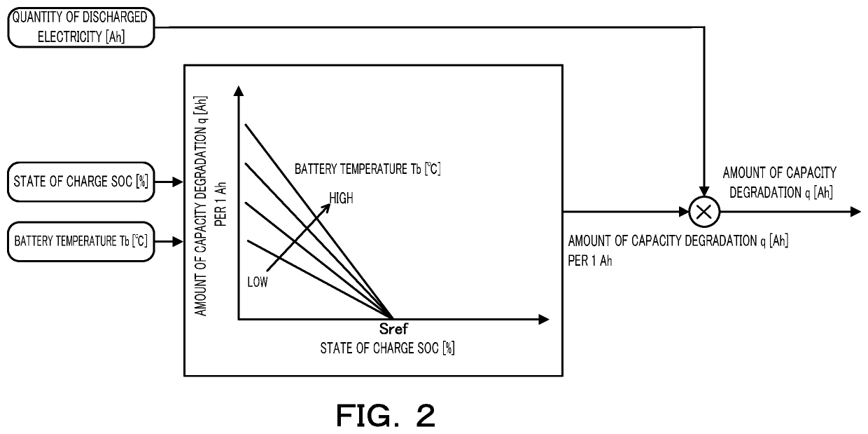

FIG. 2 is a block diagram illustrating a procedure of calculating the amount of capacity degradation Q. As illustrated, the procedure of calculating the amount of capacity degradation Q sets an amount of capacity degradation q [Ah] per 1 Ah, based on the state of charge SOC and the battery temperature Tb and subsequently multiplies the amount of capacity degradation q per 1 Ah by a quantity of discharged electricity [Ah] that is obtained by multiplying the battery current Ib by a discharge time. An amount of capacity degradation setting map shown in FIG. 2 is used to set the amount of capacity degradation q per 1 Ah. This amount of capacity degradation setting map sets the amount of capacity degradation q such as to increase with a decrease in the state of charge SOC and to increase with an increase in the battery temperature Tb in a range that the state of charge SOC is lower than a predetermined ratio Sref.

The HVECU 70 is configured as a CPU-based microprocessor and includes a ROM configured to store processing programs, a RAM configured to temporarily store data, input/output ports and a communication port, in addition to the CPU, although not being illustrated. Signals from various sensors are input into the HVECU 70 via the input port. The signals input into the HVECU 70 include, for example, an ignition signal from an ignition switch 80, a shift position SP from a shift position sensor 82 configured to detect an operating position of a shift lever 81, and a vehicle speed V from a vehicle speed sensor 88. The input signals also include an accelerator position Acc from an accelerator pedal position sensor 84 configured to detect a depression amount of an accelerator pedal 83 and a brake pedal position BP from a brake pedal position sensor 86 configured to detect a depression amount of a brake pedal 85.

The HVECU 70 is connected with the engine ECU 24, the motor ECU 40 and the battery ECU 52 via the respective communication ports to send and receive various control signals and data to and from the engine ECU 24, the motor ECU 40 and the battery ECU 52 as described above.

The vehicle 20 of the embodiment having the configuration described above is driven in a hybrid drive (HV drive) mode or is driven in an electric drive (EV drive) mode. In the HV drive mode, the vehicle 20 is driven with operation of the engine 22. In the EV drive mode, the vehicle 20 is driven with stop of operation of the engine 22.

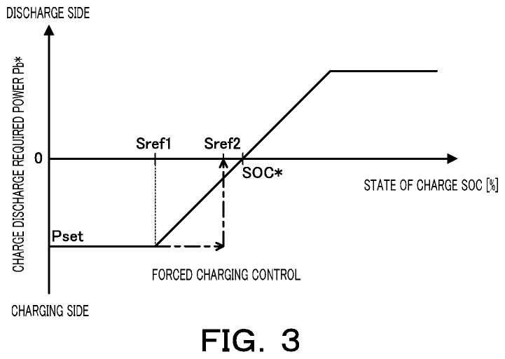

The HVECU 70 first sets a required torque Td* that is required for driving (i.e., that is to be output to the driveshaft 36), based on the accelerator position Acc input from the accelerator pedal position sensor 84 and the vehicle speed V input from the vehicle speed sensor 88. The HVECU 70 subsequently calculates a driving required power Pdrv* that is required for driving by multiplying the set required torque Td* by a rotation speed Nr of the driveshaft 36. The rotation speed Nr of the driveshaft 36 used here may be, for example, a rotation speed Nm2 of the motor MG2 or a rotation speed obtained by multiplying the vehicle speed V by a conversion factor. The HVECU 70 subsequently sets a charge discharge required power Pb* that is required for the battery 50 (more specifically, that is to be charged into the battery 50 or to be discharged from the battery 50), based on the state of charge SOC of the battery 50. According to the embodiment, a procedure of setting the charge discharge required power Pb* specifies and stores in advance a relationship between the state of charge SOC of the battery 50 and the charge discharge required power Pb* in the form of a charge discharge required power setting map in the ROM and reads a value of the charge discharge required power Pb* corresponding to a given value of the state of charge SOC from the map. One example of the charge discharge required power setting map is shown in FIG. 3. As shown in FIG. 3, in the charge discharge required power setting map, the charge discharge required power Pb* is set such as to increase the discharging power with an increase in the state of charge SOC in a range that the state of charge SOC is higher than a target state of charge SOC* (for example, 60%) and to increase the charging power with a decrease in the state of charge SOC in a range that the state of charge SOC is lower than the target state of charge SOC*, in order to make the state of charge SOC approach the target state of charge SOC*. The HVECU 70 then sets a vehicle required power Pe* that is required for the vehicle 20 by subtracting the charge discharge required power Pb* of the battery 50 (where the charge discharge required power Pb* takes a positive value when the battery 50 is discharged) from the calculated driving required power Pdrv*.

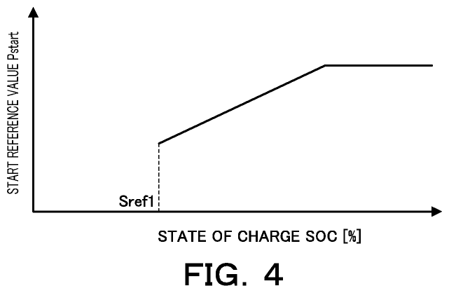

The HVECU 70 subsequently determines whether the current drive mode of the vehicle 20 is the HV drive mode or the EV drive mode. When it is determined that the current drive mode is the EV drive mode, the HVECU 70 performs an engine start determination process to determine whether the engine 22 is to be started. The engine start determination process compares the vehicle required power Pe* with a start reference value Pstart and determines that the engine 22 is to be started when the vehicle required power Pe* is equal to or larger than the start reference value Pstart, while determining that the engine 22 is not to be started when the vehicle required power Pe* is smaller than the start reference value Pstart. According to the embodiment, a procedure of setting the start reference value Pstart specifies and stores in advance a relationship between the state of charge SOC and the start reference value Pstart in the form of a start reference value setting map in the ROM and reads a value of the start reference value Pstart corresponding to a given value of the state of charge SOC from the map. One example of the start reference value setting map is shown in FIG. 4. As shown in FIG. 4, in the start reference value setting map, the start reference value Pstart is set such as to increase with an increase in the state of charge SOC in a range that the start reference value Pstart is equal to or larger than a predetermined value Sref1, which is used as a forced charging start reference value described later. According to a modification, the start reference value Pstart may be set, based on the vehicle speed V in addition to the state of charge SOC. When the HVECU 70 determines that the engine 22 is not to be started by the engine start determination process, the HVECU 70 determines that the vehicle 20 continues driving in the EV drive mode, sets a torque command Tm1* of the motor MG1 equal to a value 0, and sets a torque command Tm2* of the motor MG2, such that the required torque Td* (i.e., the driving required power Pdrv*) is output to the driveshaft 36 in a range of the input limit Win and the output limit Wout of the battery 50. The HVECU 70 then sends the torque commands Tm1* and Tm2* to the motor ECU 40. The motor ECU 40 performs switching control of the respective transistors included in the inverters 41 and 42, such that the motors MG1 and MG2 are respectively driven with the torque commands Tm1* and Tm2*.

When the HVECU 70 determines that the engine 22 is to be started by the engine start determination process, on the other hand, the drive mode of the vehicle 20 is shifted from the EV drive mode to the HV drive mode. The HVECU 70 accordingly performs an engine start process that uses the motor MG1 to motor and start the engine 22. The engine start process causes a predetermined motoring torque to be output from the motor MG1, so as to increase the rotation speed of the engine 22. The engine start process starts the operation of the engine 22 when the rotation speed Ne of the engine 22 exceeds a starting rotation speed Nestart. When the engine 22 is started and the drive mode is shifted to the HV drive mode, the HVECU 70 sets a target operation point of the engine 22 (i.e., a target rotation speed Ne* and a target torque Te*) and the torque commands Tm1* and Tm2* of the motors MG1 and MG2, such that the the vehicle required power Pe* is output from the engine 22 and that the required torque Td* is output to the driveshaft 36 in the range of the input limit Win and the output limit Wout of the battery 50. According to the embodiment, a procedure of setting the target operation point (the target rotation speed Ne* and the target torque Te*) of the engine 22 specifies in advance an optimum operation line that provides an optimal fuel consumption by taking into account the noise, the vibration and the like among operation points of the engine 22 (defined by the rotation speed and the torque) and determines and sets an operation point (defined by the rotation speed and the torque) corresponding to the vehicle required power Pe* on the optimum operation line. The HVECU 70 sends the set target operation point (the target rotation speed Ne* and the target torque Te*) of the engine 22 to the engine ECU 24, while sending the torque commands Tm1* and Tm2* of the motors MG1 and MG2 to the motor ECU 40. The engine ECU 24 performs, for example, intake air flow control, fuel injection control and ignition control of the engine 22, such that the engine 22 is operated on the basis of the target operation point. The motor ECU 40 controls the inverters 41 and 42 as described above.

When it is determined that the current drive mode is the HV drive mode, on the other hand, the HVECU 70 performs an engine stop determination process to determine whether the engine 22 is to be stopped. The engine stop determination process compares the vehicle required power Pe* with a stop reference value Pstop and determines that the engine 22 is not to be stopped when the vehicle required power Pe* is equal to or larger than the stop reference value Pstop, while determining that the engine 22 is to be stopped when the vehicle required power Pe* is smaller than the stop reference value Pstop. The stop reference value Pstop is set to a smaller value that is smaller than the start reference value Pstart by a predetermined value according to an engine start and stop reference value setting process. This sets a hysteresis to the start reference value Pstart, in order to prevent frequent repetition of the starts and stops of the engine 22. When the HVECU 70 determines that the engine 22 is not to be stopped by the engine stop determination process, the HVECU 70 keeps the HV drive mode. When the HVECU 70 determines that the engine 22 is to be stopped by the engine stop determination process, on the other hand, the HVECU 70 performs an engine stop process that causes the motor MG1 to decrease the rotation speed of the engine 22 and thereby stop the engine 22 and shifts the drive mode from the HV drive mode to the EV drive mode. The series of controls in the HV drive mode and in the EV drive mode are described above.

When the state of charge SOC of the battery 50 becomes lower than a predetermined forced charging start reference value Sref1 (for example, 40%), the HVECU 70 performs forced charging control to forcibly charge the battery 50 until the state of charge SOC of the battery 50 becomes equal to or higher than a forced charging stop reference value Sref2 (for example, 50%). The forced charging control prohibits the engine 22 from being stopped (i.e., prohibits the drive mode from being shifted to the EV drive mode) irrespective of the determination result of the engine stop determination process described above and sets a predetermined power Pset for charging to the charge discharge required power Pb*, such that the battery 50 is charged with a relatively large electric power in a range of the state of charge SOC from the forced charging start reference value Sref1 to the forced charging stop reference value Sref2 as shown in FIG. 3.

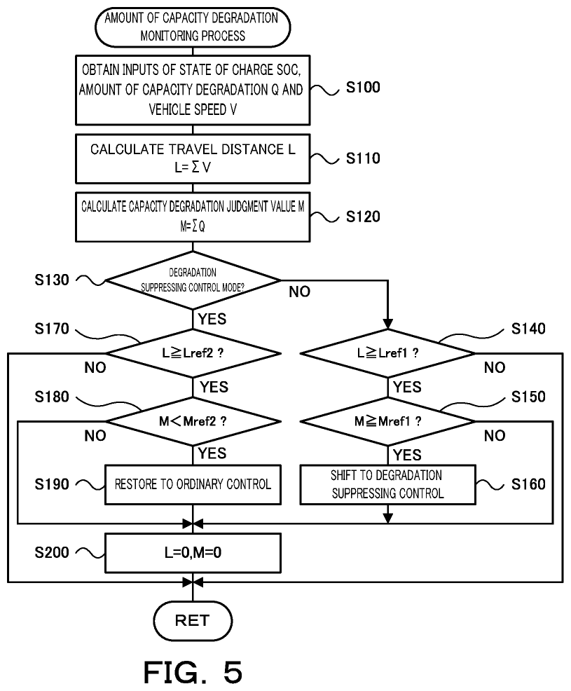

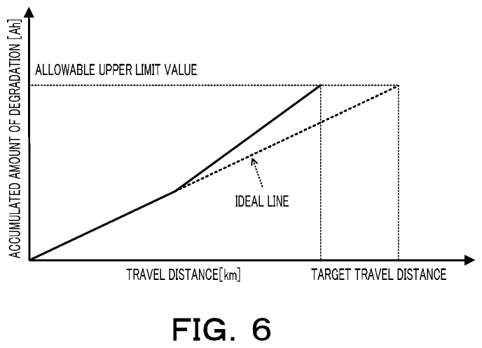

The following describes a series of processing to monitor the degradation of the positive electrode capacity of the battery 50 in the vehicle 20 of the embodiment having the configuration described above. FIG. 5 is a flowchart showing one example of an amount of capacity degradation monitoring process performed by the CPU of the battery ECU 52. This routine is performed repeatedly at predetermined time intervals (for example, at every several msec). As shown in FIG. 6, it is desirable in design that an accumulated amount of degradation of the positive electrode capacity of the battery 50 reaches an allowable upper limit value when the vehicle is driven by a travel distance guaranteed by an automobile manufacturer (target travel distance). More specifically, it is preferable that the accumulated amount of degradation increases along an ideal line with an increase in the total travel distance as shown by a broken line curve in FIG. 6. The allowable upper limit value herein denotes an accumulated amount of degradation of a decrease in capacity in the full charge state (full charge capacity) from an initial value (100%) to a predetermined value (for example, 20%). The full charge capacity has an inflection point where a decrease in the full charge capacity is accelerated with an increase in total discharge capacity. The predetermined value may be a value between the initial value to the inflection point of the full charge capacity. With regard to the battery 50 that uses a nickel compound as the positive electrode material (nickel storage battery), degradation of the positive electrode capacity is more likely to proceed when the battery 50 is used in a low SOC range where the state of charge SOC of the battery 50 is lower than the predetermined ratio Sref. Accordingly, in some cases, the accumulated amount of degradation is likely to increase at a larger increase rate than the increase rate of the ideal line and reach the allowable upper limit value prior to a drive of the vehicle 20 by the target travel distance as shown by a solid line curve in FIG. 6. Accordingly, the vehicle 20 of the embodiment performs the amount of capacity degradation monitoring process to monitor whether the accumulated amount of degradation of the positive electrode capacity of the battery 50 increases at the larger increase rate than the increase rate of the ideal line and thereby monitor the degradation progress of the positive electrode capacity.

When the amount of capacity degradation monitoring process is triggered, the CPU of the HVECU 70 first obtains the inputs of the state of charge SOC, the amount of capacity degradation Q and the vehicle speed V (step S100). The state of charge SOC and the amount of capacity degradation Q input here are values calculated as described above. The vehicle speed V input here is a value detected by the vehicle speed sensor 88 and received by the HVECU 70 by communication.

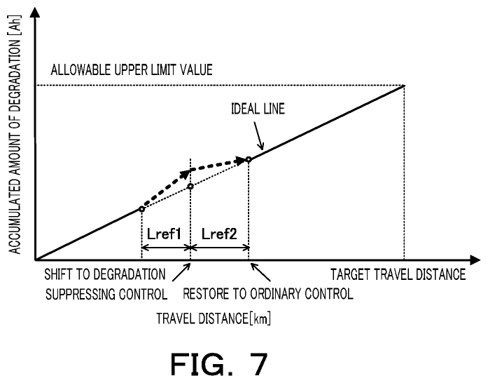

The CPU subsequently integrates the input values of the vehicle speed V to calculate a travel distance L (step S110) and integrates the input values of the amount of capacity degradation Q to calculate a capacity degradation judgment value M (step S120). The CPU subsequently determines whether the current control mode is a degradation suppressing control mode or not (step S130). When it is determined that the current control mode is not the degradation suppressing control mode but an ordinary control mode, the CPU subsequently determines whether the travel distance L calculated at step S110 is equal to or greater than a first predetermined distance Lref1 (step S140). When it is determined that the travel distance L is less than the predetermined distance Lref1, the CPU determines that the current timing is not a timing to determine the degradation progress of the positive electrode capacity and then terminates the amount of capacity degradation monitoring process. When it is determined that the travel distance L is equal to or greater than the predetermined distance Lref1, on the other hand, the CPU subsequently determines whether the capacity degradation judgment value M calculated at step S120 is equal to or larger than a first judgment reference value Mref1 (step S150). The first judgment reference value Mref1 is a reference value used to determine whether the slope of an increase in the accumulated amount of degradation (i.e., the degradation progress) is steeper than the slope of the ideal line as shown by a broken line arrow in a traveling section of the first predetermined distance Lref1 shown in FIG. 7. This first judgment reference value Mref1 is determined to be a larger value by a predetermined value (margin value) than an amount of increase in the integrated value of the amount of capacity degradation Q by the slope of the ideal line relative to traveling of the first predetermined distance Lref1.

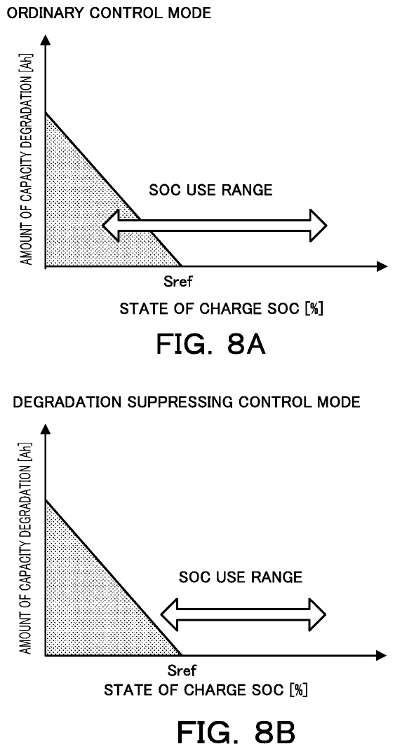

When it is determined at step S150 that the capacity degradation judgment value M is smaller than the first judgment reference value Mref1, the CPU determines that the degradation progress of the positive electrode capacity is appropriate. The CPU accordingly maintains the ordinary control mode, initializes both the travel distance L and the capacity degradation judgment value M to a value 0 (step S200), and then terminates the amount of capacity degradation monitoring process. When it is determined at step S150 that the capacity degradation judgment value M is equal to or larger than the first judgment reference value Mref1, on the other hand, the CPU determines that the degradation progress of the positive electrode capacity is more rapid than the approximate degradation progress. The CPU accordingly shifts the control mode from the ordinary control mode to the degradation suppressing control mode (step S160), initializes both the travel distance L and the capacity degradation judgment value M to the value 0 (step S200), and then terminates the amount of capacity degradation monitoring process. As shown in FIGS. 8A and 8B, the degradation suppressing control mode is a mode of controlling charge and discharge of the battery 50 such that the use frequency of a low SOC range (filled area in FIGS. 8A and 8B) where the state of charge SOC is lower than the predetermined ratio Sref and where the degradation of the positive electrode capacity of the battery 50 is more likely to proceed, is less in the degradation suppressing control mode (shown in FIG. 8B) than the use frequency in the ordinary control mode (shown in FIG. 8A). The details of the degradation suppressing control mode will be described later.

When the control mode is shifted from the ordinary control mode to the degradation suppressing control mode, it is determined at step S130 that the current control mode is the degradation suppressing control mode in a next cycle of the amount of capacity degradation monitoring process. In this case, the CPU subsequently determines whether the travel distance L is equal to or greater than a second predetermined distance Lref2 (step S170). According to the embodiment, the second predetermined distance Lref2 is determined to be a longer distance than the first predetermined distance Lref1. This is because the first predetermined distance Lref1 needs to ensure a travel distance that is required to estimate the degradation progress of the positive electrode capacity, while the second predetermined distance Lref2 needing to ensure a sufficient execution time of the degradation suppressing control mode with a view to eliminating the state that the degradation progress is more rapid than expected. When it is determined at step S170 that the travel distance L is less than the second predetermined distance Lref2, the CPU terminates the amount of capacity degradation monitoring process. When it is determined at step S170 that the travel distance L is equal to or greater than the second predetermined distance Lref2, on the other hand, the CPU subsequently determines whether the capacity degradation judgment value M calculated at step S120 is smaller than a second judgment reference value Mref2 (step S180). The second judgment reference value Mref2 is a reference value used to determine whether the slope of an increase in the accumulated amount of degradation (i.e., the degradation progress) is gentler than the slope of the ideal line as shown by a broken line arrow in a traveling section of the second predetermined distance Lref2 shown in FIG. 7. This second judgment reference value Mref2 is determined to be a smaller value by a predetermined value (margin value) than an amount of increase in the integrated value of the amount of capacity degradation Q by the slope of the ideal line relative to traveling of the second predetermined distance Lref2.

When it is determined at step S180 that the capacity degradation judgment value M is equal to or larger than the second judgment reference value Mref2, the CPU determines that rapid progress of degradation of the positive electrode capacity has not yet been overcome. The CPU accordingly maintains the degradation suppressing control mode, initializes both the travel distance L and the capacity degradation judgment value M to the value 0 (step S200), and then terminates the amount of capacity degradation monitoring process. When it is determined at step S180 that the capacity degradation judgment value M is smaller than the second judgment reference value Mref2, on the other hand, the CPU determines that the rapid progress of degradation of the positive electrode capacity has been overcome. The CPU accordingly restores the control mode from the degradation suppressing control mode to the ordinary control mode (step S190), initializes both the travel distance L and the capacity degradation judgment value M to the value 0 (step S200), and then terminates the amount of capacity degradation monitoring process.

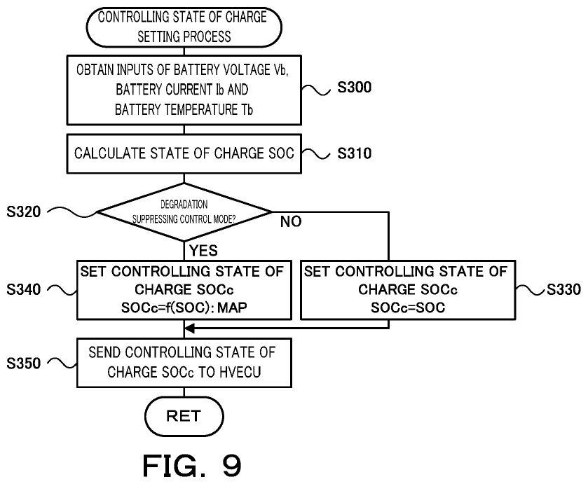

The following describes a series of operations of the degradation suppressing control. FIG. 9 is a flowchart showing one example of a controlling state of charge setting process performed by the battery ECU 52. This routine is performed repeatedly at predetermined time intervals (for example, at every several msec).

When the controlling state of charge setting process is triggered, the CPU of the battery ECU 52 first obtains the inputs of the battery voltage Vb from the voltage sensor 51a, the battery current Ib from the current sensor 51b and the battery temperature Tb from the temperature sensor 51c (step S300) and calculates the state of charge SOC of the battery 50, based on the inputs of the battery voltage Vb, the battery current Ib and the battery temperature Tb (step S310). The CPU subsequently determines whether the current control mode is the degradation suppressing control mode (step S320). When it is determined that the current control mode is not the degradation suppressing control mode but the ordinary control mode, the CPU sets the state of charge SOC calculated at step S310 to a controlling state of charge SOCc (step S330), sends the set controlling state of charge SOCc to the HVECU 70 (step S350) and then terminates the controlling state of charge setting process. When receiving the controlling state of charge SOCc, the HVECU 70 performs the drive control described above by using the received controlling state of charge SOCc as the state of charge SOC. More specifically, the HVECU 70 sets the charge discharge required power Pb*, based on the controlling state of charge SOCc, sets the start reference value Pstart used for the engine start determination process and the stop reference value Pstop used for the engine stop determination process, based on the controlling state of charge SOCc, and also determines whether the forced charging control is to be performed or not, based on the determination of whether the controlling state of charge SOCc is lower than the forced charging start reference value Sref1.

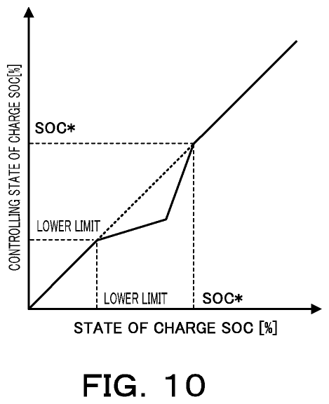

When it is determined at step S320 that the current control mode is the degradation suppressing control mode, on the other hand, the CPU uses a state of charge adjustment map to adjust the state of charge SOC calculated at step S310 and sets the adjusted state of charge SOC to the controlling state of charge SOCc (step S340), sends the set controlling state of charge SOCc to the HVECU 70 (step S350) and then terminates the controlling state of charge setting process. One example of the state of charge adjustment map is shown in FIG. 10. According to the embodiment, as shown in FIG. 10, the state of charge adjustment map sets the controlling state of charge SOCc to be lower than the state of charge SOC in a range between the target state of charge SOC* and a lower limit value of a control range. The HVECU 70 sets the charge discharge required power Pb*, based on the controlling state of charge SOCc input from the battery ECU 52. This enables the battery 50 to be charged with the higher electric power in the degradation suppressing control mode, compared with the charging power provided in the ordinary control mode. The HVECU 70 also sets the start reference value Pstart and the stop reference value Pstop, based on the controlling state of charge SOCc input from the battery ECU 52. This enables the start timing of the engine 22 to be advanced and enables the stop timing of the engine 22 to be delayed in the degradation suppressing control mode, compared with the start timing and the stop timing in the ordinary control mode. Accordingly, this reduces the frequency in use of the EV drive mode in the degradation suppressing control mode, compared with the frequency in the ordinary control mode. Furthermore, the HVECU 70 determines whether the forced charging control is to be performed or not by determining whether the controlling state of charge SOCc input from the battery ECU 52 is lower than the forced charging start reference value Sref1. This accordingly advances the start timing of forced charging control in the degradation suppressing control mode, compared with the start timing in the ordinary control mode. This series of processing minimizes the use of the battery 50 in the low SOC range of lower than the predetermined ratio Sref and thereby suppresses the progress of degradation of the positive electrode capacity. Accordingly, this slows the degradation progress of the positive electrode capacity of the battery 50 as shown by the broken line arrow in the traveling section of the second predetermined distance Lref2 shown in FIG. 7 and makes the accumulated amount of degradation relative to the total travel distance closer to the ideal line.

As described above, the vehicle 20 of the embodiment integrates the amount of capacity degradation Q of the battery 50 during the drive of the first predetermined distance Lref1. When the integrated value of the amount of capacity degradation (capacity degradation judgment value M) is equal to or larger than the first judgment reference value Mref1, the vehicle 20 shifts the control mode to the degradation suppressing control mode that performs control to suppress charging and discharging of the battery 50 in the low SOC range compared with the ordinary control mode. Degradation of the positive electrode capacity of the battery 50 proceeds when the battery 50 using a nickel compound as the positive electrode material is used in the low state of charge (SOC) range. Accordingly, minimizing the use of the battery 50 in the low SOC range suppresses degradation of the positive electrode capacity. As a result, this more appropriately controls the progress of degradation of the positive electrode capacity by the long-term use and suppresses the performance degradation of the battery 50. The degradation suppressing control mode is set only when the integrated value of the amount of capacity degradation (capacity degradation judgment value M) is equal to or larger than the first judgment reference value Mref1. This configuration ensures the more sufficient performance of the battery 50 and reduces the influence on the drive control of the vehicle 20, compared with a configuration of continuously setting the degradation suppressing control mode. For example, allowing the use of the battery 50 in the low SOC range in the ordinary control mode ensures the sufficient drivable distance in the EV drive mode.

Furthermore, when the control mode is shifted to the degradation suppressing control mode, the vehicle 20 of the embodiment integrates the amount of capacity degradation Q of the battery 50 during the drive of the second predetermined distance Lref2. When the integrated value of the amount of capacity degradation (capacity degradation judgment value M) is smaller than the second judgment reference value Mref2, the vehicle 20 restores the control mode to the ordinary control mode. Changing over the control mode between the ordinary control mode and the degradation suppressing control mode enables the degradation progress of the positive electrode capacity of the battery 50 to be closer to an appropriate degradation progress, irrespective of the use conditions of the vehicle 20. Moreover, the second predetermined distance Lref2 is set to be longer than the first predetermined distance Lref1. This ensures the sufficient execution period of the degradation suppressing control and enables the degradation progress of the positive electrode capacity to be easily restored to the appropriate degradation progress.

Additionally, in the degradation suppressing control mode, the vehicle 20 of the embodiment adjusts the state of charge SOC that is used in the process of setting the charge discharge required power Pb*, the process of setting the start reference value Pstart and the stop reference value Pstop and the process of determining whether the forced charging control is to be performed, to be lower than the actual state of charge SOC calculated based on the conditions of the battery 50, for example, the battery current Ib. This configuration provides the degradation suppressing control mode by a simple process of only changing the procedure of setting the state of charge SOC based on the conditions of the battery 50.

In the degradation suppressing control mode, the vehicle 20 of the embodiment adjusts the controlling state of charge SOCc that is used for the series of control of the vehicle 20 (more specifically, the process of setting the charge discharge required power Pb*, the process of setting the start reference value Pstart and the stop reference value Pstop and the process of determining whether the forced charging control is to be performed) to be lower than the actual state of charge SOC calculated based on the conditions of the battery 50. A modified procedure of setting the charge discharge required power Pb* may use a different charge discharge required power setting map in the degradation suppressing control mode from the charge discharge required power setting map used in the ordinary control mode to set the higher charge discharge required power Pb* on the charging side relative to the state of charge SOC in the degradation suppressing control mode than the charge discharge required power Pb* set in the ordinary control mode. Furthermore, a modified procedure of setting the start reference value Pstart and the stop reference value Pstop may use a different start reference value setting map in the degradation suppressing control mode from the start reference value setting map used in the ordinary control mode to set the smaller start reference value Pstart and the smaller stop reference value Pstop relative to the state of charge SOC in the degradation suppressing control mode than the start reference value Pstart and the stop reference value Pstop set in the ordinary control mode. Moreover, a modified procedure of determining whether the forced charging control is to be performed may heighten the forced charging start reference value Sref1 that is used to determine whether the forced charging control is to be started, in the degradation suppressing control mode to be higher than the forced charging start reference value Sref1 used in the ordinary control mode. In this modification, the forced charging stop reference value Sref2 may similarly be heightened, such that the interval between the forced charging start reference value Sref1 and the forced charging stop reference value Sref2 in the degradation suppressing control mode is kept equal to the interval in the ordinary control mode. For example, when the forced charging start reference value Sref1 is 40% and the forced charging stop reference value Sref2 is 50% in the ordinary control mode, the forced charging start reference value Sref1 may be heightened to 45% and the forced charging stop reference value Sref2 may be heightened to 55% in the degradation suppressing control mode.

In the vehicle 20 of the embodiment, the second predetermined distance Lref2 is set to be longer than the first predetermined distance Lref1. According to a modification, however, the second predetermined distance Lref2 may be set to be equal to the first predetermined distance Lref1 or may be set to be shorter than the first predetermined distance Lref1.

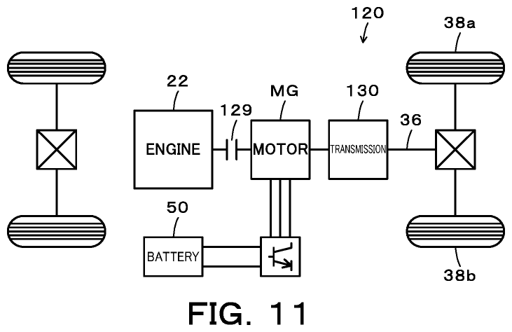

The vehicle 20 of the embodiment is configured such that the planetary gear 30 is connected with the engine 22, the motor MG1 and the driveshaft 36 that is linked with the drive wheels 38a and 38b and that the motor MG2 is connected with the driveshaft 36. The present disclosure is also applicable to a vehicle 120 according to a modification configured such that a motor MG is connected via a transmission 130 with a driveshaft 36 that is linked with drive wheels 38a and 38b and that an engine 22 is connected via a clutch 129 with a rotating shaft of the motor MG as shown in FIG. 11.

As described above, according to one aspect of the present disclosure, there is provided a vehicle including an internal combustion engine; a storage battery configured to be charged with electric power that is generated by using power from the internal combustion engine and to use a nickel compound as a positive electrode material; and a control device configured to set a state of charge of the storage battery based on a condition of the storage battery and to perform drive control that includes charge and discharge control of the storage battery, based on the set state of charge. The control device integrates an amount of degradation of positive electrode capacity of the storage battery during drive of a first predetermined distance, and when an integrated value of the amount of degradation is equal to or larger than a first predetermined value, the control device performs a degradation suppressing control to suppress charging and discharging of the storage battery in a low state of charge range where the state of charge is lower than a predetermined ratio that accelerates degradation of the positive electrode capacity, compared with charging and discharging of the storage battery in the low state of charge range in an ordinary control.

The vehicle according to this aspect of the present disclosure integrates the amount of degradation of the positive electrode capacity of the storage battery during the drive of the first predetermined distance and performs the degradation suppressing control to suppress charging and discharging of the storage battery in the low state of charge range when the integrated value of the amount of degradation is equal to or larger than the first predetermined value, compared with charging and discharging of the storage battery in the low state of charge range in the ordinary control. Degradation of the positive electrode capacity of a nickel storage battery, which uses the nickel compound as the positive electrode material, proceeds when the storage battery is used in the low state of charge range. Performing the degradation suppressing control minimizes the use of the storage battery in the low state of charge range and thereby suppresses degradation of the positive electrode capacity. As a result, this more appropriately controls the progress of degradation of the positive electrode capacity by the long-term use and suppresses the performance degradation of the storage battery. The degradation suppressing control is performed only when the integrated value of the amount of degradation is equal to or larger than the first predetermined value. This configuration ensures the more sufficient performance of the storage battery and reduces the influence on the control of the vehicle, compared with a configuration of continuously performing the degradation suppressing control. The “drive control including charge discharge control of the storage battery” includes, for example, a control process of setting a required charge discharge power that is required for the storage battery, such that the state of charge of the storage battery approaches a target state of charge, and performing control to charge and discharge the storage battery, based on the set required charge discharge power; a control process of performing control to forcibly charge the storage battery with a predetermined charging power when the state of charge of the storage battery is lower than a lower limit value; and a control process of setting a start reference value that is used to determine whether the internal combustion engine is to be started, based on the state of charge of the storage battery, and performing control to start the internal combustion engine when a vehicle required power that is required for the vehicle in response to an accelerator operation amount becomes equal to or greater than the set start reference value. The “amount of degradation of the positive electrode capacity” includes an estimation based on the state of charge of the storage battery and the temperature of the storage battery.

In the vehicle according to the above aspect of the present disclosure, when performing the degradation suppressing control, the control device may integrate an amount of degradation of the positive electrode capacity during a drive of a second predetermined distance and may stop execution of the degradation suppressing control when the integrated value of the amount of degradation is smaller than a second predetermined value. The configuration of performing the degradation suppressing control and stopping the degradation suppressing control enables a degradation progress of the positive electrode capacity of the storage battery to become close to an appropriate degradation progress, irrespective of a use condition of the vehicle. In this case, the second predetermined distance may be longer than the first predetermined distance. This configuration ensures the sufficient execution period of the degradation suppressing control and enables the degradation progress of the positive electrode capacity to be readily restored to the appropriate degradation progress.

Further, in the vehicle according to the above aspect of the present disclosure, the control device may set the state of charge in the degradation suppressing control to be lower than the state of charge in the ordinary control. This configuration enables the control to be changed over from the ordinary control to the degradation suppressing control by a simple process of only changing the procedure of setting the state of charge based on the condition of the storage battery.

Furthermore, in the vehicle according to the above aspect of the present disclosure, when the state of charge is lower than a lower limit value, the control device may perform forced charging control that controls the storage battery to be forcibly charged. In this aspect, the lower limit value in the degradation suppressing control may be set to be larger than the lower limit value in the ordinary control, or the state of charge in the degradation suppressing control may be set to be lower than the state of charge in the ordinary control. The degradation suppressing control of this aspect enables a start timing of the forced charging control to be advanced, thereby suppressing a decrease in state of charge and delaying the degradation progress of the positive electrode capacity.

The following describes the correspondence relationship between the primary components of the embodiment and the primary components of the disclosure described in Summary. The engine 22 of the embodiment corresponds to the “internal combustion engine”, the battery 50 corresponds to the “storage battery”, the engine ECU 24, the motor ECU 40, the battery ECU 52 and HVECU 70 correspond to the “control device”.

The correspondence relationship between the primary components of the embodiment and the primary components of the disclosure, regarding which the problem is described in Summary, should not be considered to limit the components of the disclosure, regarding which the problem is described in Summary, since the embodiment is only illustrative to specifically describes the aspects of the disclosure, regarding which the problem is described in Summary. In other words, the disclosure, regarding which the problem is described in Summary, should be interpreted on the basis of the description in the Summary, and the embodiment is only a specific example of the disclosure, regarding which the problem is described in Summary.

The aspect of the disclosure is described above with reference to the embodiment. The disclosure is, however, not limited to the above embodiment but various modifications and variations may be made to the embodiment without departing from the scope of the disclosure.

### INDUSTRIAL APPLICABILITY

The technique of the disclosure is preferably applicable to the manufacturing industries of the vehicle and so on.

What is claimed is:

1. A vehicle, comprising:
an internal combustion engine; a storage battery configured to be charged with electric power that is generated by using power from the internal combustion engine and to use a nickel compound as a positive electrode material; and a control device configured to set a state of charge of the storage battery based on a condition of the storage battery and to perform drive control that includes charge and discharge control of the storage battery, based on the set state of charge, wherein
the control device integrates an amount of degradation of positive electrode capacity of the storage battery during drive of a first predetermined distance, and
when an integrated value of the amount of degradation is equal to or larger than a first predetermined value, the control device performs a degradation suppressing control to suppress charging and discharging of the storage battery in a low state of charge range where the state of charge is lower than a predetermined ratio that accelerates degradation of the positive electrode capacity, compared with charging and discharging of the storage battery in the low state of charge range in an ordinary control.

2. The vehicle according to claim 1,
wherein when performing the degradation suppressing control, the control device integrates an amount of degradation of the positive electrode capacity during a drive of a second predetermined distance and stops execution of the degradation suppressing control when the integrated value of the amount of degradation is smaller than a second predetermined value.

3. The vehicle according to claim 2,
wherein the second predetermined distance is longer than the first predetermined distance.

4. The vehicle according to claim 1,
wherein the control device sets the state of charge in the degradation suppressing control to be lower than the state of charge in the ordinary control.

5. The vehicle according to claim 1,
wherein the control device performs forced charging control that controls the storage battery to be forcibly charged when the state of charge is lower than a lower limit value, and
the lower limit value in the degradation suppressing control is set to be larger than the lower limit value in the ordinary control.

6. The vehicle according to claim 1,
wherein the control device performs forced charging control that controls the storage battery to be forcibly charged when the state of charge is lower than a lower limit value, and
the state of charge in the degradation suppressing control is set to be lower than the state of charge in the ordinary control.
